(19) United States
(12) Patent Application Publication
(10) Pub. No.: US 2013/0311833 A1
(43) Pub. Date: Nov. 21, 2013

(54) COMPUTING DEVICE AND METHOD FOR TESTING COMPONENTS OF THE COMPUTING DEVICE

(71) Applicants: HONG FU JIN PRECISION INDUSTRY (Shenzhen) CO., LTD, (US); HON HAI PRECISION INDUSTRY CO., LTD., New Taipei (TW)

(72) Inventor: FENG GAO, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 13/783,434

(22) Filed: Mar. 4, 2013

(30) Foreign Application Priority Data
May 18, 2012 (CN) 201210155070.5

(51) Int. Cl. G06F 11/22

(52) U.S. Cl. CPC G06F 11/2273
USPC 714/40

(57) ABSTRACT

A method of testing components of a computing device by obtaining a serial number of the computing device, and searching a database for test results of the computing device by using the serial number. The method determines whether the computing device has passed an electronic circuitry test when the electronic circuitry test result of the computing device has been found in the database, and tests components of the computing device when the computing device has passed the electronic circuitry test. A component test result of the computing device is saved in the database, and displayed on the display.

### BACKGROUND

1. Technical Field

Embodiments of the present disclosure relate to testing, and more particularly to a computing device and a method for testing components of the computing device.

2. Description of Related Art

When a product (e.g., a computing device) is manufactured and before it can be sold to the consumer, the product is tested. Generally, the electronic circuitry may be tested first before other hardware components of the computing device is tested. However, because many computing devices must be tested, the other hardware components may be inadvertently tested before the computing device has passed the electronic circuitry test. Therefore, there is room for improvement in the art.

### BRIEF DESCRIPTION OF THE DRAWINGS

FIG. 1 is a block diagram of one embodiment of a computing device including a testing system.

FIG. 2 is a block diagram of function modules of the testing system included in the computing device of FIG. 1.

FIG. 3 is a flowchart of one embodiment of a testing method to test components of the computing device of FIG. 1.

FIG. 4 is a sub-flowchart of one embodiment of step S5 included in the FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

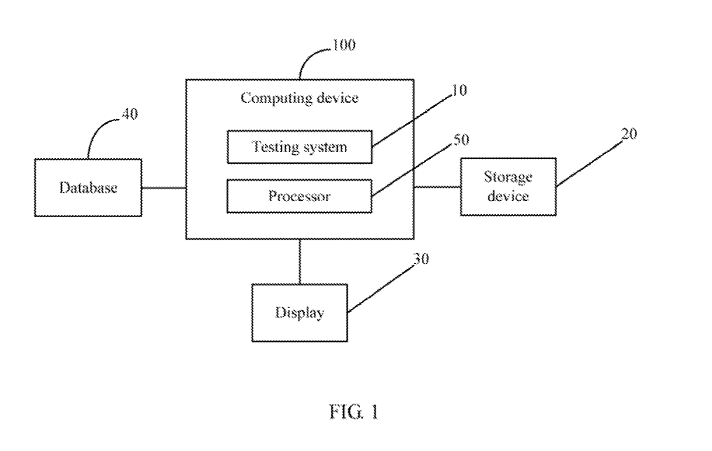

FIG. 1 is a block diagram of one embodiment of a computing device 100. The computing device 100 includes a testing system 10 and at least one processor 50. A storage device 20, a display 30, and a database 40 are connected to the computing device 100. In other embodiments, the storage device 20, the display 30, and the database 40 may be components in the computing device 100.

The testing system 10 is used to test components of the computing device 100. In one embodiment, the testing system 10 predetermines parameter information of each component (e.g., a CPU and a flash memory) of the computing device 100, and stores the predetermined parameter information into the storage device 20. A detailed description will be provided below.

The display 30 may be used for interaction between a tester and the computing device 100. For example, the display 30 displays a component test result for the tester. The database 40 may be used to record test results of the computing device 100. For example, the database 40 records an electronic circuitry test result and other kinds of test results of the computing device 100.

In one embodiment, the database 40 records the test results of the computing device 100 according to a serial number of the computing device 100. The serial number is a unique code assigned for the computing device 100.

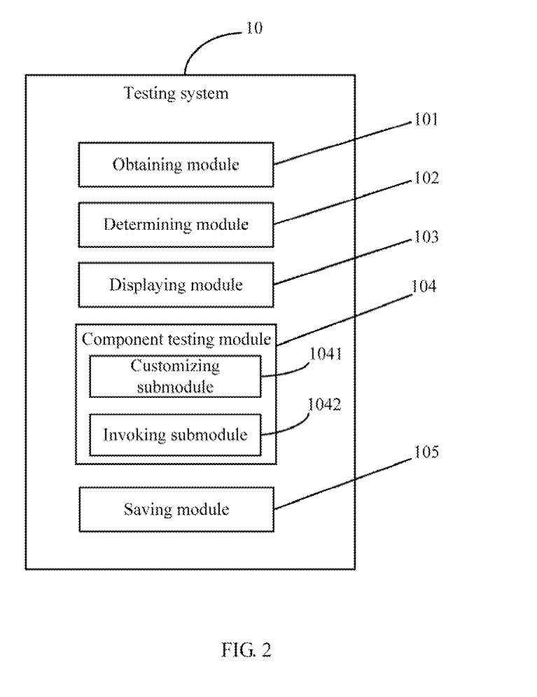

FIG. 2 is a block diagram of function modules of the testing system 10 included in the computing device 100 of FIG. 1. In one embodiment, the testing system 10 may include an obtaining module 101, a determining module 102, a displaying module 103, a component testing module 104, and a saving module 105. The component testing module 104 may include a customizing submodule 1041 and an invoking submodule 1042.

The modules 101-104 and the submodules 1041-1042 comprise computerized codes in the form of one or more programs that may be stored in the storage device 20. The computerized code includes instructions that are executed by the at least one processor 50.

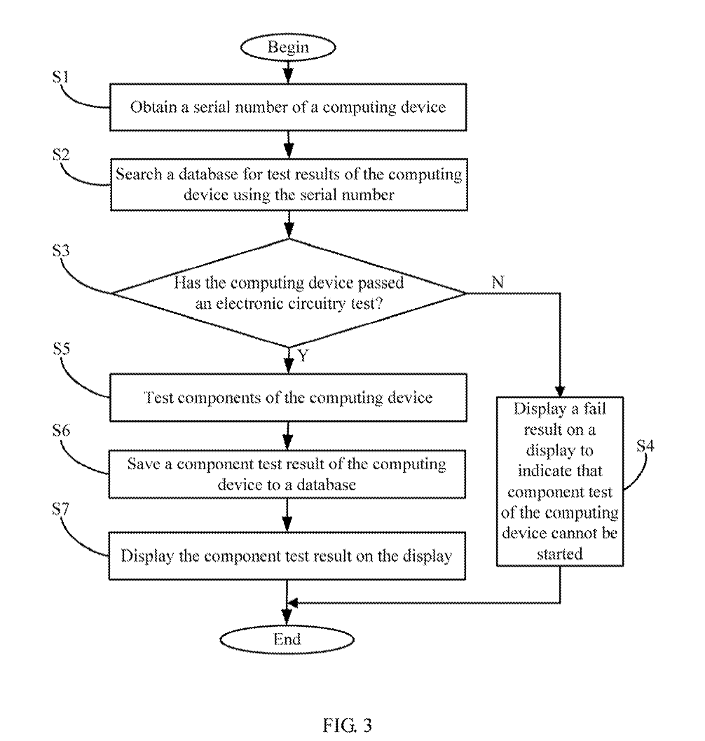

FIG. 3 is a flowchart of one embodiment of a method to test components of the computing device 100. Depending on the embodiment, additional steps may be added, others deleted, and the ordering of the steps may be changed.

In step S1, the obtaining module 101 obtains the serial number of the computing device 100. In one embodiment, the obtaining module 101 obtains the serial number of the computing device 100 from a bar code reader. A manufacturer records the serial number on a barcode, which may be pasted on the computing device 100 and can be read by the bar code reader, then the obtaining module 101 obtains the serial number from the bar code reader.

In step S2, the determining module 102 searches the database 40 for test results of the computing device 100 using the serial number. As mentioned before, the database 40 records test results (e.g., an electronic circuitry test result) of the computing device 100 according to the serial number. In one embodiment, the determining module 102 searches the database 40 for the electronic circuitry test result of the computing device 100.

In step S3, the determining module 102 determines whether the computing device 100 has passed the electronic circuitry test based on the electronic circuitry test result of the computing device 100.

If the electronic circuitry test result indicates that the computing device 100 has not passed the electronic circuitry test, the determining module 102 determines that the component test of the computing device 100 should not be started, the process goes to step S4. If the electronic circuitry test result indicates that the computing device 100 has passed the electronic circuitry test, the determining module 102 determines that the component test of the computing device 100 can be started, the process goes to step S5.

In step S4, the displaying module 103 displays a fail result on the display 30 to indicate that the component test of the computing device 100 should not be performed. For example, “No electronic circuitry test was performed.” may be a message.

In step S5, the component testing module 104 tests components of the computing device 100. The components include, but are not limited to a CPU, a memory, a cache memory, a hard drive, and a network card. Details of testing the components will provide below.

In step S6, the saving module 105 saves the component test result of the computing device 100 to the database 40, according to the serial number of the computing device 100. In one embodiment, the saving module 105 saves the component test result in the form of codes.

For example, if the component testing module 104 tests a CPU of the computing device 100 first, and then tests a memory, a cache memory, a hard driver, and a network card in order. If all of the other components except the CPU are qualified, the saving module 105 saves the component test result in form of “001” to indicate that the CPU is not qualified. If all of the other components except the cache memory are qualified, the saving module 105 saves the component test result in form of “003” to indicate that the cache memory is not qualified.

If all of the other components except the CPU and the cache memory are qualified, the saving module 105 saves the component test result in forms of “001” and “003”, if all of the components of the computing device 100 are qualified, the saving module 105 saves the component test result in form of “000” to indicate that the computing device 100 pass the component test.

In step S7, the displaying module 103 displays the component test result on the display 30. For example, the displaying module 103 displays a message to indicate that the CPU is not qualified on the display 30, to inform the tester to check the CPU.

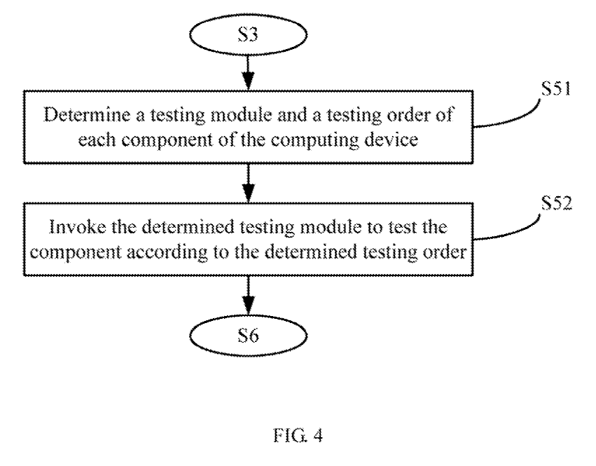

FIG. 4 is a sub-flowchart of step S5 included in FIG. 3. Depending on the embodiment, additional steps may be added, others deleted, and the ordering of the steps may be changed.

In step S51, the customizing submodule 1041 determines a testing module and a testing order of each component of the computing device 100 according to test requirements. For example, if the tester wants to test the CPU, the memory, the cache memory, the hard driver, and the network card. The customizing submodule 1041 determines a first testing module to test the CPU.

In one embodiment, the customizing submodule 1041 determines the first testing module to obtain parameter information (e.g., capacity) of the CPU, and compares the obtained parameter information of the CPU with predetermined parameter information of the CPU that is stored in the storage device 20, to determine whether the CPU is qualified.

Similarly, the customizing submodule 1041 determines a second testing module to test the memory, a third testing module, a fourth testing module, and a fifth testing module respectively to test the cache memory, the hard driver, and the network card.

The customizing submodule 1041 further determines a testing order of the component of the computing device 100. For example, if the tester wants to test the CPU first, and then tests the memory, the cache memory, the hard driver, and the network card in order. The customizing submodule 1041 determines the CPU should be tested first, the memory should be tested after the CPU has been tested by the first testing module. Similarly, the cache memory should be tested after the memory has been tested by the second testing module.

In step S52, the invoking submodule 1042 invokes the determined testing module to test each component according to the determined testing order, and then the process goes to step S6. For example, the invoking submodule 1042 invokes the first testing module to test the CPU, and invokes the second testing module to test the memory after the first testing module tested the CPU.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method for testing components of a computing device, the computing device comprising a storage device, a display, and at least one processor, the method comprising:
obtaining a serial number of the computing device;
searching a database for test results of the computing device using the serial number, determining whether the computing device has passed an electronic circuitry test when the electronic circuitry test result of the computing device has been found in the database;
testing components of the computing device when the computing device has passed the electronic circuitry test;
saving a component test result of the computing device in the database; and
displaying the component test result on the display.

2. The method according to claim 1, further comprising:
displaying a fail result on the display to indicate that the component test of the computing device should not be performed, under the condition that the computing device has not passed the electronic circuitry test.

3. The method according to claim 1, further comprising:
determining a testing module and a testing order of each component of the computing device according to test requirements; and
invoking the determined testing module to test the component according to the determined testing order.

4. The method according to claim 3, further comprising:
determining that the component of the computing device is qualified when parameter information of the component in the test result is consistent with predetermined parameter information stored in the storage device.

5. The method according to claim 1, wherein the serial number of the computing device is obtained from a bar code reader.

6. A computing device, comprising:
a storage device;
a display;
at least one processor; and
one or more modules that are stored in the storage device and are executed by the at least one processor, the one or more modules comprising:
an obtaining module that obtains a serial number of the computing device;
a determining module that searches a database for test results of the computing device using the serial number, determining whether the computing device has passed an electronic circuitry test when the electronic circuitry test result of the computing device has been found in the database;
a component testing module that tests components of the computing device when the computing device has passed the electronic circuitry test;
a saving module that saves a component test result of the computing device into the database; and
a displaying module that displays the component test result on the display.

7. The computing device according to claim 6, wherein the displaying module further displays a fail result on the display to indicate that the component test of the computing device should not be performed, under the condition that the computing device has not passed the electronic circuitry test.

8. The computing device according to claim 6, wherein the component testing module comprising:
a customizing submodule that determines a testing module and a testing order of each component of the computing device according to test requirements; and
a invoking submodule that invokes the determined testing module to test the component according to the determined testing order.

9. The computing device according to claim 8, wherein the testing module determines that the component of the computing device is qualified when parameter information of the component in the test result is consistent with predetermined parameter information stored in the storage device.

10. The computing device according to claim 6, wherein the serial number of the computing device is obtained from a bar code reader.

11. A non-transitory medium storing a set of instructions, the set of instructions capable of being executed by a processor of a computing device to perform a method of testing components of the computing device, the computing device further comprising a display, the method comprising:
obtaining a serial number of the computing device;
searching a database for test results of the computing device using the serial number, determining whether the computing device has passed an electronic circuitry test when the electronic circuitry test result of the computing device has been found in the database;
testing components of the computing device when the computing device has passed the electronic circuitry test;
saving a component test result of the computing device in the database; and
displaying the component test result on the display.

12. The medium of claim 11, further compring:
displaying a fail result on the display to indicate that the component test of the computing device should not be performed, under the condition that the computing device has not passed the electronic circuitry test.

13. The medium of claim 11, further comprising:
determining a testing module and a testing order of each component of the computing device according to test requirements; and
invoking the determined testing module to test the component according to the determined testing order.

14. The medium of claim 13, further comprising:
determining that the component of the computing device is qualified when parameter information of the component in the test result is consistent with predetermined parameter information stored in the storage device.

15. The medium of claim 11, wherein the serial number of the computing device is obtained from a bar code reader.
